(19) United States
(12) Patent Application Publication
(10) Pub. No.: US 2002/0140194 A1
(43) Pub. Date: Oct. 3, 2002

(54) Braking structure of scooter

(76) Inventor: Anthony Shaw, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/843,792

(22) Filed: Apr. 30, 2001

(30) Foreign Application Priority Data
Mar. 28, 2001 (TW) 90204768

(51) Int. Cl. B62M 1/00

(52) U.S. Cl. 280/87.041; 280/87.021

(57) ABSTRACT

A scooter braking structure comprises an arresting member pivoted in the receiving slot of a scooter bottom board and provided with a tread portion and a braking portion. A spring urges the inner wall of the receiving slot and the arresting member such that the arresting member swivels between a braking position and a releasing position. When the arresting member is located at the braking position, the spring is compressed by the arresting member such that the braking portion comes in contact with the scooter rear wheel to slow down or stop the scooter in motion. When the arresting member is located at the releasing position, the spring returns to its original form to push the arresting member such that the braking portion is separated from the scooter rear wheel.

### FIELD OF THE INVENTION

The present invention relates generally to a scooter, and more particularly to a braking structure of the scooter.

### BACKGROUND OF THE INVENTION

As shown in FIG. 1, a prior art scooter braking structure comprises a bottom board 1, a rear wheel 2 pivoted to the rear end of the bottom board 1, and a wheel cover 3 which is urged by an urging member 4 to remain a distance away from the inner side 3 a of the wheel cover 3. As the wheel cover 3 is exerted on by an external force, the braking action is effected by the inner side 3 a which presses against the wheel 2.

The prior art scooter braking structure has drawbacks. In the first place, the braking action brought about by the wheel cover 3 is often compromised by the mud that is deposited on the inner side 3a of the wheel cover 3. In addition, the wheel cover 3 is apt to swivel aside from the rear wheel 2 in view of the fact that the inner side 3a is located at a greater distance away from the pivoting center. As a result, when the wheel cover 3 comes in contact with the rear wheel 2, both the wheel cover 3 and the rear wheel 2 are susceptible to wear which shortens the service life spans of the wheel cover 3 and the rear wheel 2.

### SUMMARY OF THE INVENTION

It is the primary objective of the present invention to provide a scooter braking structure capable of a stable braking action.

It is another objective of the present invention to provide a scooter braking structure which does not cause an adverse effect on the rear wheel and the rear wheel cover.

The braking structure of the present invention is mounted at the rear end of the scooter bottom board and is formed of an arresting member pivoted in a receiving slot of the bottom board and provided at one end with a tread portion and at other end with a braking portion; a spring fastened at one end with the inner wall of the receiving slot and at other end with the arresting member, thereby enabling the arresting member to swivel between a braking position and a releasing position. When the arresting member is located at the braking position, the spring is compressed by the arresting member such that the braking portion comes in contact with the scooter rear wheel to slow down or stop the scooter in motion. When the arresting member is located at the releasing position, the spring returns to its original position such that it pushes the arresting member to result in separation of the braking portion from the rear wheel.

### BRIEF DESCRIPTION OF THE DRAWINGS

FIG. 1 shows a schematic view of a prior art scooter braking structure.

FIG. 2 shows a perspective view of a scooter of a preferred embodiment of the present invention.

FIG. 3 shows a partial schematic view of the scooter of the preferred embodiment of the present invention.

FIG. 4 shows an exploded view of the preferred embodiment of the present invention.

FIG. 5 shows a partial side view of the preferred embodiment of the present invention.

FIG. 6 shows a schematic view of the braking structure of the preferred embodiment of the present invention in action.

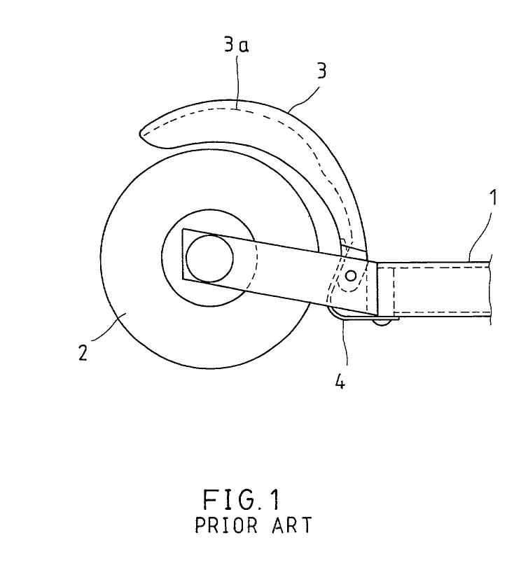

### DETAILED DESCRIPTION OF THE INVENTION

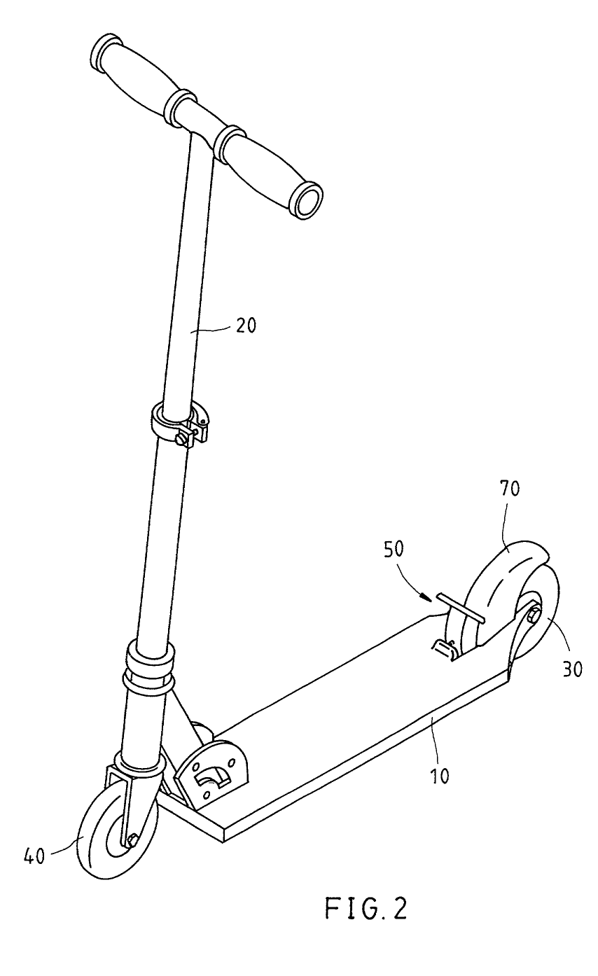

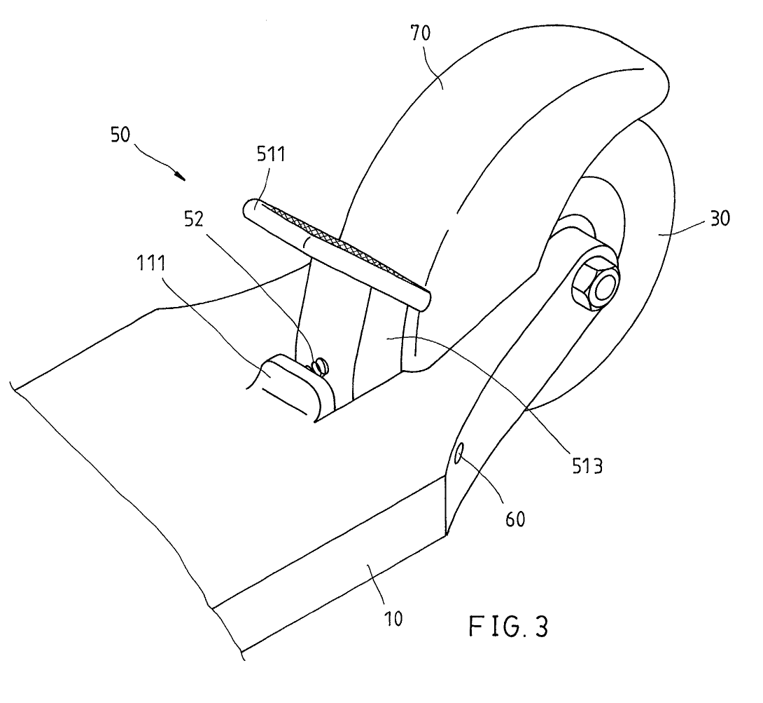

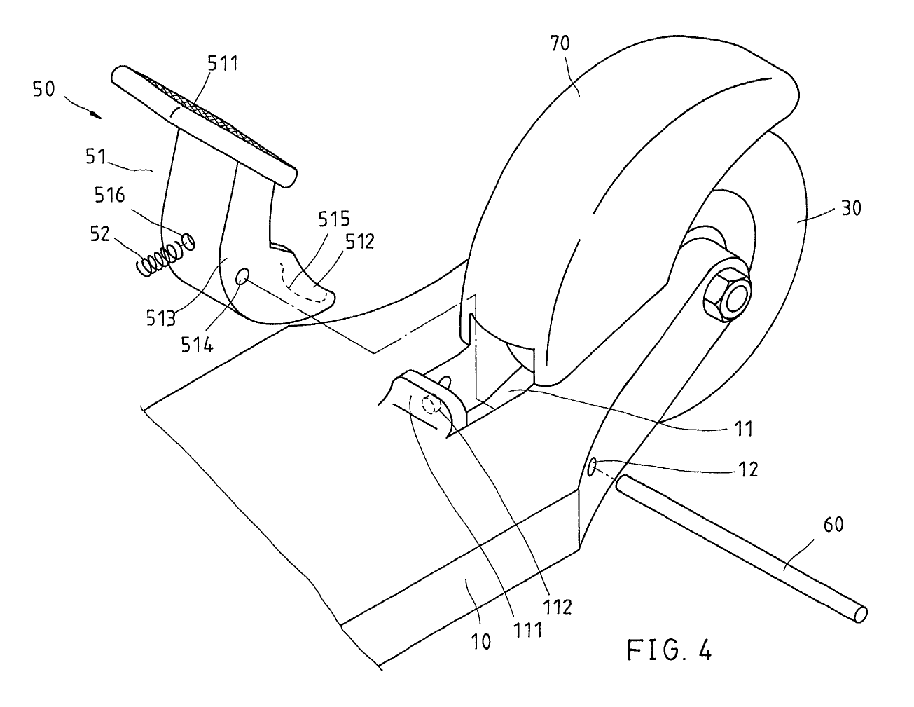

As shown in FIGS. 2-4, a scooter bottom board 10 is provided at the front end with a handlebar frame 20, and at the rear end with a rear wheel 30. A front wheel 40 is pivoted to the bottom end of the handlebar frame 20. The rear wheel 30 is covered by a wheel cover 70 which is fastened with the bottom board 10. The present invention is characterized by a braking structure 50 which is mounted at the rear end of the bottom board 10 and is formed of an arresting member 51 and a spring 52.

The arresting member 51 has a tread portion 511, a braking portion 512, and a body portion 513 connected between the tread portion 511 and the braking portion 512. The tread portion 511 is provided with a knurled portion for providing a friction between the tread portion 511 and the foot. The body portion 513 is provided with a through hole 514 and a recessed slot 516 which is located over the through hole 514. The braking portion 512 is provided with a recessed surface 515 complementary with the periphery of the rear wheel 30.

The arresting member 51 is disposed in the receiving slot 11 of the rear end of the bottom board 10. The receiving slot 11 is provided with an urging portion 111 extending from the inner wall of the receiving slot 11. The urging portion 111 is provided with a recessed hole 112. The bottom board 10 is provided in two sides with a through hole 12 in communication with the receiving slot 11. A connection member 60 is put into the through hole 514 of the body 513 to enable the arresting member 51 to swivel between a releasing position and a braking position.

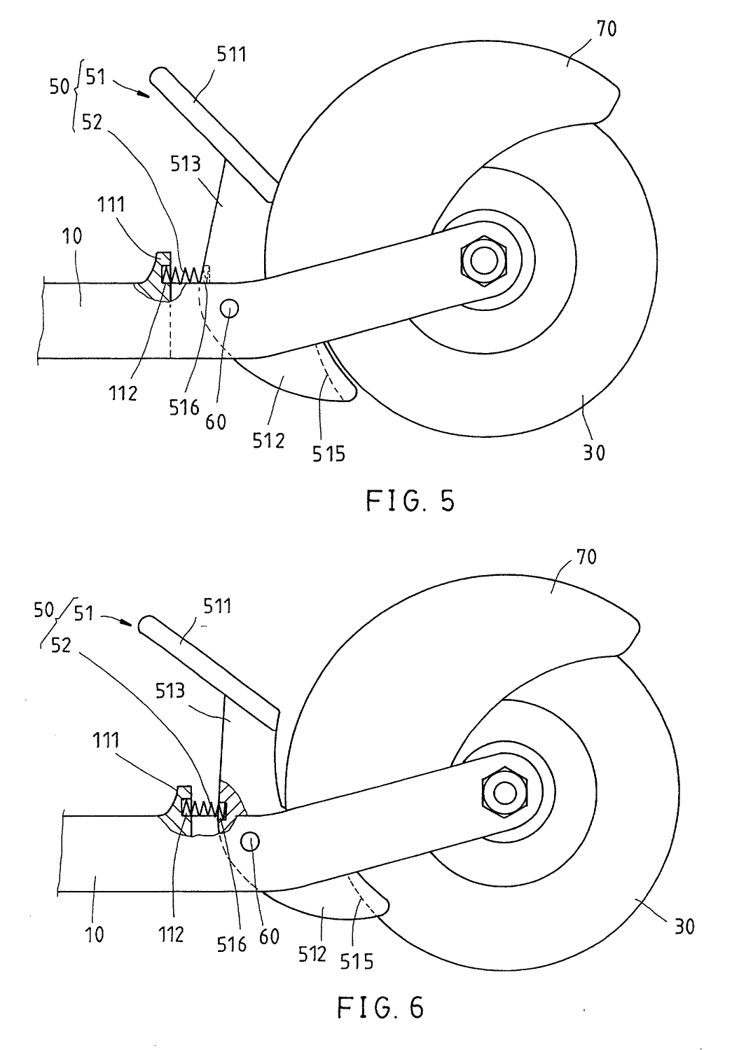

As shown in FIG. 5, the spring 52 is disposed in the receiving slot 11 such that one end of the spring 52 urges the recessed hole 112 of the urging portion 111, and that other end urges the recessed slot 516 of the body portion 513. As the arresting member 51 is kept at the releasing position, the recessed surface 515 of the braking portion 512 is separated from the rear wheel 30.

As shown in FIG. 6, when the tread portion 511 is pressed downward, the arresting member 51 swivels on the pivoting center such that the body portion 513 presses against the spring 52. The spring 52 is thus compressed. The braking portion 512 swivels such that the recessed surface 515 comes in contact with the rear wheel 30 so as to slow down or stop the scooter in motion.

As the tread portion 511 is relieved of the external force exerting thereon, the compressed spring 52 is caused to decompress such that the arresting member 51 is pushed by the spring 52 to swivel back to the releasing position.

In light of the braking action of the present invention being brought about by the contact between the recessed surface 515 of the braking portion 512 and the rear wheel 30, the present invention is capable of a stable braking action, thanks to the relatively large contact area of the recessed surface 515 of the braking portion 512. In addition, the recessed surface 515 is located in proximity of the connection member 60, the recessed surface 515 is not apt to sway. The shape of the recessed surface 515 and the peripheral surface of the rear wheel 30 are complementary. The recessed surface 515 is strategically located at the front of the rear wheel 30 to prevent the deposition of mud, thereby enhancing the braking effect of the recessed surface 515 of the braking portion 512.

What is claimed is:

1. A scooter braking structure mounted at the rear end of a scooter bottom board which is provided at the rear end with a receiving slot, said braking structure comprising:
an arresting member pivoted in said receiving slot and provided at one end with a tread portion and at other end with a braking portion;
a spring urging at one end the inner wall of said receiving slot and at other end with said arresting member, thereby enabling said arresting member to swivel between a braking position and a releasing position, said spring being compressed by said arresting member located at said braking position such that said braking portion comes in contact with said rear wheel to slot down or stop the scooter in motion, said compressed spring being decompressed to push said arresting member located at said releasing position such that said arresting member located at said releasing position such that said braking portion is separated from said rear wheel.

2. The scooter braking structure as defined in claim 1, wherein said braking portion has a recessed surface of a shape complementary with the peripheral surface of said rear wheel, said recessed surface coming in contact with said rear wheel at the time when said arresting member is located at said braking position.

3. The scooter braking structure as defined in claim 1, wherein said tread portion is provided with a skidproof knurled portion.

4. The scooter braking structure as defined in claim 1, wherein said arresting member has a recessed slot; wherein said receiving slot has an urging portion for two ends of said spring to press against.

5. The scooter braking structure as defined in claim 1, wherein said receiving slot of the bottom board is provided at the rear end with a wheel cover for covering the scooter rear wheel.

6. The scooter braking structure as defined in claim 1, wherein said braking portion is located at the front of the scooter rear wheel.

7. The scooter braking structure as defined in claim 1, wherein said tread portion and said spring are located at one side of a pivoting center of said arresting member; wherein said braking portion is located at other side of said pivoting center.

8. The scooter braking structure as defined in claim 1, wherein said tread portion and said spring are located at one side of a pivoting center of said arresting member; wherein said braking portion is located at other side of said pivoting center such that said braking portion is opposite in location to the front of the scooter rear wheel.

9. The scooter braking structure as defined in claim 4, wherein said urging portion is provided with a recessed hole; wherein said spring urges said recessed hole.
